(19) United States
(12) Patent Application Publication
(10) Pub. No.: US 2004/0111003 A1
(43) Pub. Date: Jun. 10, 2004

(54) Chalcogenide ceramics for the disposal of radioactive and/or hazardous waste

(76) Inventors: Pedro M. Buarque de Macedo, Bethesda, MD (US); Werner Lutze, Chevy Chase, MD (US)

Correspondence Address: Charles R. Macedo, Esq., Amster, Rothstein & Ebenstein, 90 Park Avenue, New York, NY, 10016, US

(21) Appl. No.: 10/314,706

(22) Filed: Dec. 9, 2002

(51) Int. Cl. G21F 9/00

(52) U.S. Cl. 588/16

(57) ABSTRACT

The present invention relates generally chalcogenide ceramics which are used to immobilize radioactive and/or hazardous waste materials contained in underground and/or aboveground storage tanks, contaminated underground soil, contaminated water supplies, and/or other incidental wastes. More particularly, in one embodiment of the present invention, a storage tank is provided which contains a composition of material comprising: (a) radioactive and/or hazardous waste components; and (b) precipitate comprising chalcogenide ceramics which controls oxidation potential of any contact water which may be present within the composition and normal ceramics, wherein the precipitates immobilize the radioactive and/or hazardous waste components.

In another embodiment of the present invention, a method of immobilizing radioactive and/or hazardous liquid materials contained in a storage tank is provided comprising the steps of: pumping into the storage tank one or more solution(s) comprising (i) sulfate and/or sulfite; (ii) food for microbes; (iii) other essential elements for microbes to grow not otherwise present in the storage tank, wherein the storage tank operates under the following conditions at the time the solution is being pumped into the storage tank: (i) the temperature of the storage tank is between 5° C. and 62° C.; (ii) the pH of the storage tank is between 3 and 10; and (iii) the redox potential of the solution in the storage tank is between −10 and +2.

### FIELD OF THE INVENTION

The present invention relates generally to chalcogenide ceramics which are used to immobilize radioactive and/or hazardous waste materials. More particularly, the present invention relates to chalcogenide ceramics used to immobilize radioactive and/or hazardous waste contained in underground and/or aboveground storage tanks, contaminated underground soil, contaminated water supplies and/or other incidental wastes.

### BACKGROUND OF THE INVENTION

Beginning at the end of World War II in the mid-1940s, plutonium processing plants began generating radioactive and/or hazardous waste material in the form of cations, anions and/or other species. Beginning in the 1960's, nuclear power plants in the United States also began generating additional radioactive and/or hazardous waste materials. These radioactive and/or hazardous waste materials have generally been classified as either high-level waste or low-level waste. A problem that the United States and other countries have faced since the 1940's is how to safely and effectively dispose of these radioactive and/or hazardous waste materials.

For example at the Hanford Site near Richland, Wash., where plutonium used in America's atomic weapons' arsenal was manufactured from 1943 to 1988, there are approximately 53 million gallons of radioactive and/or hazardous waste materials contained within the site. However, not all of the radioactive and/or hazardous waste material has been contained within these tanks. More than a million gallons of high-level radioactive waste have already leaked out of the rusting tanks buried in desert hills of eastern Washington state—waste that is now percolating slowly toward the Columbia River seven miles away and the city of Portland, Oreg., 200 miles downstream, present significant health and safety risks to the environment as well as Portland (and surrounding) community.

While the Hanford Site is by far the largest site containing hazardous and/or radioactive waste, other nuclear reprocessing sites also exist in the United States and elsewhere which contain hazardous and/or radioactive waste materials.

For example, the West Valley Site, located near Buffalo, N.Y. was a commercial and other nuclear reprocessing site whose high-level radioactive waste has been removed from waste storage tanks on site. Upon removal, the high-level radioactive waste is separated into Separated High-Level Waste and Low Activity Waste. Separated High-Level Waste comprises waste resulting from separation of high level radioactive constituents from the high-level radioactive waste. Low Activity Waste is the waste that remains after separation of the highly radioactive constituents from the high-level radioactive waste. At the West Valley Site, the Separated High-Level Waste has been vitrified using other processes developed by a team including one of the present inventors at the Vitreous State Laboratory of The Catholic University of America. However, these waste storage tanks on site at the West Valley Site still contain some high-level radioactive waste which still needs to be immobilized. Further, in the 1970s, at the West Valley Site, low-level waste has been processed using technology developed by others and buried at the low-level West Valley Site. Unfortunately, this low-level waste has leaked into the surrounding soil.

Another example, the Savannah River Site, located at the edge of the Savannah River in South Carolina, is a nuclear reprocessing site which produces plutonium and other fuels for America's atomic weapons' arsenal. The Savannah River Site has also generated significant amounts of hazardous and/or radioactive wastes over the years. The Savannah River Site has also used other processes developed by a team including one of the present inventors at the Vitreous State Laboratory of The Catholic University of America to immobilize mixed wastes, which contains both low-level radioactive waste materials and hazardous waste materials. The Savannah River Site has also used processes developed by others to remove and vitrify Separated High-Level Waste from the high-level waste contained in storage tanks. In the past few years, the Savannah River Site has attempted to immobilize two of these storage tanks from which almost all of the high-level waste has been removed by filing them with cement, the same technique that is being used to immobilize the Low Active Waste at the Savannah River Site. However, to date, despite having filled these tanks with cement, they still have not been considered safe enough to be closed.

A further example, the Oak Ridge Site, located in Oak Ridge Tenn., is a diffusion plant in operation since World War II to separate Uranium 235 (U²³⁵), which is fissionable, from Uranium 238 (U²³⁸), which is not as easily fissionable. The Oak Ridge Site is still used today to produce fissionable materials for nuclear power plants. A method that was attempted to immobilize the radioactive and/or hazardous waste from the Oak Ridge Site involved the use of cement. A large amount of the cement immobilized waste was buried, and thereafter found to leak. This unfortunate event has caused some to be very concerned about using cement as a method to immobilize radioactive and/or hazardous wastes.

While the technique of using cement to immobilize the radioactive and/or hazardous waste in the storage tanks at the Hanford Site has been considered, concerns have been expressed as to whether the cement will crack, whether it will not properly solidify as has been experienced at Oak Ridge, whether the cement will not immobilize Technetium (Tc), Selenium (Se) and possibly Uranium (U), and whether, prior to using cement, all materials need to be removed from a tank before immobilization which is economically (if not practically) infeasible.

At Hanford, it is presently assumed that there will likely be approximately 1% of the current material remaining in the storage tank, thus all the waste material will not be removed from the storage tank before immobilization. As such, traditional cement filler would not be appropriate. Further, because the waste that is likely to remain in the storage tanks at Hanford after being emptied and cleaned will most probably be high-level waste, other techniques like vitrification are not likely to be appropriate for the tanks themselves, which are very large and not easily susceptible to vitrification processes.

It has also been recognized that some sort of getter has to be used with a cement immobilization technique for the storage tanks at sites like the Hanford Site. A getter is an additive placed in cement or soils or other fillers that will absorb and immobilize cations, anions and/or other species contained in hazardous and/or radioactive materials. Thus, the Department of Energy has explained that “[i]f low-cost getter materials can be developed for waste disposal, requirements on waste forms can be reduced, potentially saving hundreds of millions of dollars in the Hanford Immobilized Waste Disposal Program.” P. A. Gauglitz, J. L. Bryant, G. M. Gasper, FY 2002 Integrated Technology Plan for the River Protection Project, DOE/ORP-2002-03, Feb. 1, 2002, Sect. 10.3.4, at p. 10.14 (“FY 2002 Plan”). While FY 2002 Plan recognizes that the Savannah River Site uses Iron Sulfide (FeS) to trap Tc, and many disposal sites use concrete to trap U, until the present invention an effective form of a getter has not been identified.

In addition to the radioactive and/or hazardous waste contained in storage tanks, the other equipment used at these sites, including, e.g., pipes, valves, etc., have been exposed to and are contaminated by radioactive and/or hazardous wastes. This contaminated equipment is referenced as “incidental wastes” herein. Appropriate immobilization and/or disposal methods are necessary for incidental wastes also.

Furthermore, as discussed above with respect to the Hanford Site, a large amount of radioactive and/or hazardous waste material has leaked from the storage tanks and related equipment over the years that also needs to be immobilized. Similarly, as discussed above with respect to the West Valley Site and the Oak Ridge Site, improperly buried waste has leaked and contaminated soil.

FY 2002 Plan recognizes that one method that is being investigated by Sandia National Laboratory to address the problem of leaking waste into the soil is the use of Apatite, a phosphate containing ceramic, to be placed on the soil below the tanks at the Hanford Site. Again, this proposal, even if ultimately found to be effective, unlike one identifying an appropriate getter for use with filler in the tank, would not preclude the tanks from leaking, and thus, would not be a sufficient long term solution for the problems presented here. Moreover, while Apatite may prove to be effective at immobilizing Tc, it does not appear likely that it will also address all the other important isotopes present in the radioactive and/or hazardous waste from the Hanford Site and other sites.

Another technique that has been proposed to treat soils contaminated with radioactive materials, and U in particular, is in situ bioremediation. The leading method for performing in situ radioactive bioremediation is described in an article coauthored by one of the present inventors, Werner Lutze et al., Microbially Mediated Reduction and Immobilization of Uranium in Groundwater at Königstein [Germany], Bioremediation of Inorganic Compounds, Vol. 6(9), pp. 155-63, from the Sixth International In Situ and On-Site Bioremediation Symposium, San Diego, Calif., (June 4-7, 2001. Eds. A. Leeson,B. M. Peyton, J. L. Means, and V. Magar) (“Lutze Uranium Waste”). Lutze Uranium Waste concludes “that indigenous microbes reduced U(VI) to U(IV) that precipitated as uranite U0₂. A large excess of mackinawite [Fe_{(1+X)}S] was also precipitated by microbially mediated reactions and was shown to provide long-term protection against an oxidative dissolution of uranite.” Similarly, in a recent publication coauthored by the same present inventor, it has been suggested that this technique may also be applied to non-radioactive hazardous elements. Werner Lutze, Weiliang Gong, and H. Eric Nuttall, Microbially mediated reduction and immobilization of uranium in groundwater, Uranium in the Aquatic Environment, pp. 437-46, from Proceedings of the International Conference Uranium Mining and Hydrogeology III and the International Mine Water Association Symposium, Freiberg, Germany (Sep. 15-21, 2002 eds. B. J. Merkel, B. Planer-Friedrich, C. Wolkersdorfer). While these results proved promising for the immobilization of U and non-radioactive hazardous materials from soils, which were deep enough to be in reducing (anaerobic) conditions, i.e., there is no oxygen present, they do not address conditions where oxygen is present, such as in surface soils, or the storage tanks containing nitrates (N0₃⁻) and/or nitrites (N0₂⁻), both of which are highly oxidizing, as is the case with the Hanford Site, the Savannah River Site, and the other sites discussed above. This technique of in situ radioactive bioremediation is further limited in that microbes will not survive in acidic environments, such as are present at the Idaho Falls Site, or in basic environments, such as are present at the Hanford, Savannah River and West Valley Sites discussed above and in cement.

Accordingly, there has been a long felt for a material which can be used to immobilize radioactive and/or hazardous waste materials contained in underground and/or aboveground storage tanks, contaminated underground soil, contaminated water supplies and/or other incidental wastes.

While the prior art is of interest, the known methods and apparatus of the prior art present several limitations, which the present invention seeks to overcome.

More particularly, it is an object of the present invention to provide a material to immobilize radioactive and/or hazardous waste materials contained in underground and/or aboveground storage tanks, contaminated underground soil, contaminated water supplies and/or other incidental wastes.

It is another object of the present invention to It is an object of the present invention to provide a storage tank containing a composition of material comprising: (a) radioactive and/or hazardous waste components; and (b) a precipitate comprising chalcogenide ceramics which controls oxidation potential of any contact water which may be present within the composition and normal ceramics, wherein the precipitate immobilize the radioactive and/or hazardous waste components.

It is a further object of the present invention to provide a method of immobilizing radioactive and/or hazardous liquid materials contained in a storage tank comprising the steps of: pumping into the storage tank one or more solution(s) comprising (i) sulfate and/or sulfite; (ii) food for microbes; and (iii) other essential elements for microbes to grow not otherwise present in the storage tank, wherein the storage tank operates under the following conditions at the time the solution is within the storage tank: (i) the temperature of the storage tank is between 5° C. and 62° C.; (ii) the pH of the storage tank is between 3 and 10; and (iii) the redox potential of the solution in the storage tank is between −10 and +2.

It is a further object of the present invention to provide a method of immobilizing a first set of radioactive and/or hazardous liquid materials contained in soil to be treated to prevent migration of the first set of radioactive and/or hazardous liquid materials from contaminated soil to uncontaminated soil comprising the steps of: pumping into the soil to be treated one or more solution(s) comprising (i) sulfate and/or sulfite; (ii) food for microbes; (iii) other essential elements for microbes to grow not otherwise present in the soil to be treated; and (iv) a second set of radioactive and/or hazardous liquid materials, wherein the soil to be treated is at least 10 m below ground.

It is a further object of the present invention to provide a method of using a material to immobilize radioactive and/or hazardous waste materials contained in underground and/or aboveground storage tanks, contaminated underground soil, contaminated water supplies and/or other incidental wastes.

These and other objects will become apparent from the foregoing description.

### SUMMARY OF THE INVENTION

It has now been found that the above and related objects of the present invention are obtained in the form of chalcogenide ceramics which can be used to immobilize radioactive and/or hazardous waste materials contained in underground and/or aboveground storage tanks, contaminated underground soil, contaminated water supplies and/or other incidental wastes.

It is also an object of the present invention to provide a storage tank containing a composition of material comprising: (a) radioactive and/or hazardous waste components; and (b) a precipitate comprising chalcogenide ceramics which controls oxidation potential of any contact water which may be present within the composition and normal ceramics, wherein the precipitate immobilize the radioactive and/or hazardous waste components.

It is a further object of the present invention to provide a method of immobilizing radioactive and/or hazardous liquid materials contained in a storage tank comprising the steps of: pumping into the storage tank one or more solution(s) comprising (i) sulfate and/or sulfite; (ii) food for microbes; and (iii) other essential elements for microbes to grow not otherwise present in the storage tank, wherein the storage tank operates under the following conditions at the time the solution is within the storage tank: (i) the temperature of the storage tank is between 5° C. and 62° C.; (ii) the pH of the storage tank is between 3 and 10; and (iii) the redox potential of the solution in the storage tank is between −10 and +2.

It is a further object of the present invention to provide a method of immobilizing a first set of radioactive and/or hazardous liquid materials contained in soil to be treated to prevent migration of the first set of radioactive and/or hazardous liquid materials from contaminated soil to uncontaminated soil comprising the steps of: pumping into the soil to be treated one or more solution(s) comprising (i) sulfate and/or sulfite; (ii) food for microbes; (iii) other essential elements for microbes to grow not otherwise present in the soil to be treated; and (iv) a second set of radioactive and/or hazardous liquid materials, wherein the soil to be treated is at least 10 m below ground.

The object of this invention is also the long term immobilization of the radioactive and/or hazardous components left behind in underground and/or aboveground storage tanks, contaminated underground soil, contaminated water supplies, and/or other incidental wastes by use of chalcogenide ceramics. The reducing conditions associated with the ceramic will present remobilization of critical radionuclides such as Tc, U and Se.

The present invention also uses a bioremediation process comprising utilization of: (i) indigenous (naturally contained in soil to be used in the process) microbes, such as oxygen-, nitrate-, iron-, and sulfate-reducers, or added microbial cultures, and (ii) an organic amendment (e.g., acetate, phosphate) in aqueous solution.

### DETAILED DESCRIPTION OF THE INVENTION

The present invention relates to chalcogenide ceramics which are used to immobilize radioactive and/or hazardous waste materials. More particularly, the present invention relates to chalcogenide ceramics used to immobilize radioactive and/or hazardous waste contained in underground and/or aboveground storage tanks, contaminated underground soil, contaminated water supplies and/or other incidental wastes.

Chalcogenide ceramics are ceramics where the oxygen links between metal atoms are replaced by bonds with atoms in the same group of the periodic table, e.g., sulfur (S), selenium (Se), tellurium (Te). A preferred chalcogenide for the present invention is sulfur in a reduced state, such as iron sulfide (FeS) which has sulfur with a valence of −2, or pyrite (FeS₂) which has sulfur with a valence of −1, or polymeric sulfur with a zero-valence. Other preferred chalcogenide ceramics that come within the scope of the invention include, for example, nickel sulfide (NiSₓ) and cobalt sulfide (CoSₓ), where x is greater than or equal to 1. For the purpose of the present invention chalcogenide ceramics can be mixtures with other compounds such as metals and/or normal ceramics including oxides and/or hydroxides. In another embodiment of the present invention the chalcogenide ceramics, when in contact with water, control the oxidation potential of any contact water which may be present. In this embodiment, the chalcogenide ceramics when in contact with water preferably contains enough sulfide (e.g., as HS⁻) to precipitate most of the multivalent metals and to support reduction of higher valence states, such as, U⁺⁶ to U⁺⁴, or Tc⁺⁷ to Tc⁺⁴. Preferably, the concentration of sulfur within the chalcogenide ceramic is about 1 wt. %. Alternatively, the concentration of sulfur should be in the range of 0.1 to 10 wt. %, or preferably, in the range of 0.3 to 3 wt %. In another embodiment, the chalcogenide ceramics have a high surface area of over 10 m²/g, and more preferably of over 100 m²/g, and even more preferably of over 200 m²/g.

In a preferred embodiment, the present invention uses chalcogenide ceramics to immobilize radioactive and/or hazardous waste materials contained in a storage tank. As discussed above, there is presently a large demand to immobilize radioactive and/or hazardous waste materials which remain in storage tanks after they have been cleaned, by as much as approximately 99%. Unfortunately, even after extensive cleaning such storage tanks still contain about 1% of the high-level waste that was originally held within such tanks. Even less than 0.1% of the high-level waste can be very dangerous, and thus still requires immobilization. The chalcogenide ceramics used in the present invention accomplishes such immobilization in a safe manner. The present invention may be used in storage tanks that originally contained high-level waste, low-level waste, and/or a combination of high-level waste and low-level waste.

In a preferred embodiment, a storage tank which has already been processed to remove as much as approximately 99% of the high-level waste previously contained therein, is pumped through one or more conduits with a ground ceramic. The present invention can also be used when less or more of the high-level waste previously contained therein has been processed, or when low-level waste or mixed waste has been previously contained in the storage tank. Thereafter, one or more solution(s) comprising (i) sulfate and/or sulfite; (ii) food for microbes; (iii) other essential elements for microbes to grow not otherwise present in the system.

With respect to the first step, ground ceramics such as soil, fly ash and/or ground rocks containing microbes, are added to the storage tank. The present invention is not limited to these materials and any ground ceramics which meet the operating conditions set forth below can be used in their stead. The purpose of adding these ground ceramics is to provide a support platform for the microbes used in the present invention to grow.

An added advantage of using ground ceramics is that such ground ceramics can in fact seal holes in the storage tank and thereby limit future leakage. In order to prevent the small particle from leaking through a storage tank hole prior to sedimentation, a preferred method of the present invention begins by introducing large particles that will produce sediment on the holes or on the soil outside the holes. Thereafter, progressively reduced particle sizes are added, such that each size acts as a filter to the next smaller size, until the hole in the storage tank is sealed. For example, and by way of illustration only, the large particles will typically begin at around 10 mesh and progressively be reduced to around 100 mesh. Alternatively, if the holes are to be patched merely by using these progressively smaller particles, then the large particles will typically again begin around 10 mesh and progressively be reduced to around 1000 mesh.

Typically, when low-level waste, such as LAW-B, is present, it will already have a large concentration of sulfate in it. The presence of such sulfate makes the use of a vitrification process for LAW-B less desirable, since it will require extensive dilution, before the waste can be immobilized. By contrast, the presence of the sulfate in such low-level waste is desirable for the present invention, and avoids the need to add additional sulfates or sulfites. Similarly, during the processing of high-level waste, a series of side streams are formed, which are separated and recombined to form the Separated High-Level Waste and Low Activity Waste. Some of these side streams may contain sufficiently low-level waste with high enough concentrations of sulfates and/or sulfites that these side streams could be diverted and used to practice the present invention. The fact that such side streams may contain radioactive and/or hazardous materials will not preclude their use with the present invention. However, even though sulfur may already be present, it may not be in sufficient quantities to practice the present invention, thus it may be necessary to add more sulfur using the same or similar techniques as would be used when little or no sulfur is already present.

In the case where sulfate and/or sulfite are not already present in sufficient amounts in the radioactive and/or hazardous material being treated, then sulfate and/or sulfite in the form of soluble salts of sulfate, sulfite, and/or bisulfite should be added. By adding sulfates and/or sulfites to water being pumped into the storage tank, the present invention insures that an adequate amount of sulfur in the form of sulfate and/or sulfite will be present. Depending upon the ground ceramic being used, the amount of sulfate and/or sulfite necessary to add will vary. For example, when fly ash is used as the ground ceramic, less sulfate and/or sulfite may be necessary to add, than if ground sandstone is used as the ground ceramic. Some fly ash will have a high concentration of sulfate because it was derived from high sulfate coals in which additional calcium was added to trap the sulfate. Enough sulfate and/or sulfite needs to be added such that the final chalcogenide ceramic has approximately 1 wt % sulfur, or alternatively between 0.1 and 10 wt % or more preferably between 0.3 and 3 wt %.

In a preferred embodiment of the present invention, sulfites are used in the form of soluble salts of sulfite and/or bisulfite. It is advantageous to use sulfites instead of sulfates since less food for microbes will be necessary to reduce the sulfite to sulfide.

The food for microbes comprise water soluble organics including vinegar, acetate, lactate, glucose and/or other organics readily digestable by microbes. Other types of soluble organics can also be used with the present invention. An appropriate selection of soluble organics can be made based upon availability, convenience and/or other economic factors.

The other essential elements comprise phosphate and/or nitrogen containing compound. These elements are the ones necessary to enable microbes to grow.

In order to facilitate the addition of these compositions into the storage tank, one or more conduits may be used to pump these solutions into the storage tank. During the microbes activity periods, the temperature of the storage tank is preferably maintained between 5° C. and 62° C., and more preferably between 8° C. and 45° C., and most preferably between 10° C. and 40° C. Also during the microbes activity periods, the pH of the system is preferably between 3 and 10, and more preferably between 4 and 9.5., and most preferably between 4.5 and 8.5. Finally, during the microbes activity periods, the redox potential (pe) of the solution in the storage tank will drop from more positive values to between −10 and +2, and more preferably to less than zero (0), and most preferably to less than −2.

In another embodiment of the present invention, after complete or partial processing of the storage tank is accordance with the present invention, water in the storage tank may be removed through one or more conduits and reused in another storage tank. When water is being recycled, it will be necessary to add more sulfate and/or sulfite, food for the microbes and other necessary ingredients before the water is introduced into the next system to be processed. One method by which the sulfate and/or sulfite may be added to the recycled water is to bubble S0₃ and/or S0₂ respectively. Because S0₂ is easier to handle, it is preferably used. As a by product of this bubbling, C0₂ is created, which will need to be cleaned before it can be released to the atmosphere. After a number of cycles, it is possible that the recycled water may be sufficiently free from radioactive and/or hazardous liquid materials such that their concentration is below the then-pertinent regulatory release limit, and the water can then be released without risk of harmful exposure to the environment.

In another embodiment of the present invention, incidental waste can be disposed of at the same time as the storage tank. Such incidental waste can be the original size of the component, size reduced or packaged. It can be placed in the storage tank prior to adding the liquid/slurries that will form the chalcogenide ceramics. Preferably the incidental waste is placed on a stand in order to permit a slurry formed by the combination of the solution with the oxidized ceramics in suspension to form a chalcogenide ceramics layer under it. The slurry preferably is a liquid with 10-60% solids in suspension. Also, the incidental waste is preferrably placed in the storage tank prior to the time that the chalcogenide ceramics begin to precipitate in order to avoid adding unnecessarily additional oxygen into the environment. After the incidental wastes are placed in the storage tank, the storage tank is preferably sealed air tight. The oxidized ceramics (e.g., powder sand stone, fly ash, contaminated or uncontaminated soil, etc.) can be added any time in this process. However, if the oxidized ceramics are added after the storage tank is sealed it will need to be through a conduit. Once the storage tank is sealed, the oxygen concentration of the storage tank atmosphere is reduced by introducing an inert gas such as oxygen or carbon dioxide, or by introducing food for the microbes.

At this point the sulfide (S⁻²) is introduced. Various possible sources of sulfide are available to be used in accordance with the present invention. For example, one source of sulfide could include a solution containing sulfate or sulfite, and food for microbes. Another source of sulfide could be by products of other waste treatment processes which are produced containing sulfite. For example, high levels of sulfur concentration are found in streams from pretreatment or other processing of solutions associated with LAW-B contained in storage tanks. In this embodiment of the present invention, the added advantage of disposing of these potentially radioactive and/or hazardous by-products of other treatment processes can reduce the total volume of material to be disposed with minimum additional cost.

In one embodiment of the present invention where the storage tank contains high-level waste of sufficient toxicity and radiation to preclude the growth of microbes, H₂S can be pumped into the bottom of the tank so as to start formation of chalcogenide ceramics.

After processing, the storage tank will have within it immobilized radioactive and/or hazardous waste, and a precipitate comprising chalcogenide ceramics which controls oxidation potential of any contact water which may be present within the composition and normal ceramics. As a result, the precipitate immobilizes the radioactive and/or hazardous waste components. By normal ceramics, the present invention includes ceramics such as oxides and/or hydroxides, including for example, sandstone, sand, granite, non-crystalline Si0₂, among others.

In another embodiment of the present invention, contaminated soil is treated to immobilize radioactive and/or hazardous waste contained therein. In this embodiment, soil between contaminated soil and uncontaminated soil is treated so as to form a barrier to prevent migration of radioactive and/or hazardous liquid materials from the contaminated soil to the uncontaminated soil. In addition to treating uncontaminated soil, the present invention may also be used to treat contaminated soil at the edge of such contamination to prevent further migration of the contamination. This technique can also be applied when the contaminated system is an aquifer. Water recycled from the storage tanks as described in the earlier embodiments may be used to treat soil in accordance with the present invention.

In order to practice this embodiment of the invention the same criteria as set forth in Lutze Uranium Waste, a copy of which is hereby incorporated by reference as if it were fully set forth herein, should be followed. Thus, the treated soil needs to be deep enough under ground to be in reducing (anaerobic) conditions, e.g., typically at least 10 m (30 feet) although sometimes it may be more or less. Furthermore, the treated soil should also be in the vadoze zone, which is the area above the water table. Alternatively, the treated soil could be in an aquifer. The present invention extends the teachings of the Lutze Uranium Waste to apply by using radioactive fluids in the contaminated soils to provide the sources of sulfur and organic feed for microbes. In the context of the present invention, because the radioactive fluids will often contain nitrates and nitrites, it will be necessary to provide extra feed for the microbes. This embodiment of the present invention will provide the unexpected advantage of immobilizing the radioactive and/or hazardous waste in the ground as well as in the water being used to treat the soil, and prevent further migration of the radioactive and/or hazardous waste in the soil being treated. Since the contaminated water being used to treat the soil will need to be otherwise decontaminated and have the resulting immobilized by-products placed in a burial site, the present invention besides being more cost effective and efficient, is likely to reduce the overall volume of radioactive and/or hazardous material to be disposed of in the soil.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

What is claimed is:

1. A storage tank containing a composition of material comprising:
a. radioactive and/or hazardous waste components; and
b. a precipitate comprising chalcogenide ceramics which controls oxidation potential of any contact water which may be present within said composition and normal ceramics,
wherein said precipitate immobilize said radioactive and/or hazardous waste components.

2. The storage tank according to claim 1, wherein said tank originally stored high-level waste.

3. The storage tank according to claim 1, wherein said radioactive and/or hazardous waste components are high-level waste.

4. The storage tank according to claim 1, wherein said radioactive and/or hazardous waste components are low-level waste.

5. The storage tank according to claim 1, wherein said chalcogenide ceramics comprises sulfur.

6. The storage tank according to claim 5, wherein said chalcogenide ceramics comprises a sulfur with a valence state of −2.

7. The storage tank according to claim 5, wherein said chalcogenide ceramics comprises a sulfur with a valence state of −1.

8. The storage tank according to claim 5, wherein said chalcogenide ceramics comprises polymeric sulfur.

9. The storage tank according to claim 1, wherein said storage tank contains said contact water in contact with said chalcogenide ceramics.

10. The storage tank according to claim 9, wherein said contact water has a redox potential of less than +2.

11. The storage tank according to claim 9, wherein said contact water has a redox potential of less than 0.

12. The storage tank according to claim 9, wherein said contact water has a redox potential of less than −2.

13. The storage tank according to claim 9, wherein said contact water has a pH between 3 and 10.

14. The storage tank according to claim 9, wherein said contact water has a pH between 4 and 10.

15. The storage tank according to claim 9, wherein said contact water has a pH between 4.5 and 8.5.

16. The storage tank according to claim 1, wherein said chalcogenide ceramics comprises a mixtures comprising a large fraction of other compounds.

17. The storage tank according to claim 16, wherein said other compounds includes oxides.

18. The storage tank according to claim 16, wherein said other compounds includes metals.

19. The storage tank according to claim 16, wherein said other compounds includes hydroxides.

20. The storage tank according to claim 1, wherein said chalcogenide ceramic has a surface area greater than 10 m²/g.

21. The storage tank according to claim 1, wherein said chalcogenide ceramic has a surface area greater than 100 m²/g.

22. The storage tank according to claim 1, wherein said chalcogenide ceramic has a surface area greater than 200 m²/g.

23. The storage tank according to claim 1, wherein said chalcogenide ceramic comprises NiSₓ, where x is greater than or equal to 1.

24. The storage tank according to claim 1, wherein said chalcogenide ceramic comprises CoSₓ, where x is greater than or equal to 1.

25. The storage tank according to claim 1, wherein said storage tank also comprises incidental waste.

26. A method of immobilizing radioactive and/or hazardous liquid materials contained in a storage tank comprising the steps of:
pumping into said storage tank one or more solution(s) comprising (i) sulfate and/or sulfite; (ii) food for microbes; and (iii) other essential elements for microbes to grow not otherwise present in said storage tank,
wherein said storage tank operates under the following conditions at the time said solution is within said storage tank: (i) the temperature of said storage tank is between 5° C. and 62° C.; (ii) the pH of said storage tank is between 3 and 10; and (iii) the redox potential of said one or more solution(s) in said storage tank is between −10 and +2.

27. The method of immobilizing radioactive and/or hazardous liquid materials according to claim 26, wherein said sulfate and/or sulfite comprises soluble salts of sulfate, sulfite, and/or bisulfite.

28. The method of immobilizing radioactive and/or hazardous liquid materials according to claim 26, wherein said sulfate and/or sulfite comprises soluble salts of sulfite, and/or bisulfite.

29. The method of immobilizing radioactive and/or hazardous liquid materials according to claim 26, wherein said food for microbes comprises water soluble organics including vinegar, acetate, lactate, glucose and/or other organics readily digestable by microbes.

30. The method of immobilizing radioactive and/or hazardous liquid materials according to claim 26, wherein said other essential elements comprise phosphate and/or nitrogen containing compound.

31. The method of immobilizing radioactive and/or hazardous liquid materials according to claim 26, wherein said temperature of said storage tank is between 8° C. and 45° C.

32. The method of immobilizing radioactive and/or hazardous liquid materials according to claim 26, wherein said temperature of said storage tank is between 10° C. and 40° C.

33. The method of immobilizing radioactive and/or hazardous liquid materials according to claim 26, wherein said pH of said storage tank is between 4 and 9.5.

34. The method of immobilizing radioactive and/or hazardous liquid materials according to claim 26, wherein said pH of said storage tank is between 4.5 and 8.5.

35. The method of immobilizing radioactive and/or hazardous liquid materials according to claim 26, wherein said atmosphere of said tank is monitored and controlled with nitrogen gas and/or carbon dioxide so as to maintain a sufficiently low concentration of hydrogen and/or other explosive gases to avoid an explosion and so as to maintain a sufficiently low concentration of oxygen such that said microbes are capable of producing a sulfur with a valence state of −2.

36. The method of immobilizing radioactive and/or hazardous liquid materials according to claim 35, wherein said redox potential of said one or more solutions in said storage tank is less than zero (0).

37. The method of immobilizing radioactive and/or hazardous liquid materials according to claim 35, wherein said redox potential of said one or more solutions in said storage tank is less than −2.

38. The method of immobilizing radioactive and/or hazardous liquid materials according to claim 26, comprising the further step of adding incidental waste to said storage tank.

39. The method of immobilizing radioactive and/or hazardous liquid materials according to claim 26, comprising the further step of pumping other liquid waste into said storage tank.

40. The method of immobilizing radioactive and/or hazardous liquid materials according to claim 26, wherein said solution is pumped into said storage tank by means of one or more input conduits.

41. The method of immobilizing radioactive and/or hazardous liquid materials according to claim 40, comprising the further step of pumping a ground ceramic into said storage tank by means of said one or more input conduits.

42. The method of immobilizing radioactive and/or hazardous liquid materials according to claim 41, wherein said ground ceramic is comprised of soil, fly ash and/or ground rocks containing microbes.

43. The method of immobilizing radioactive and/or hazardous liquid materials according to claim 42, wherein said ground ceramic is progressively adjusted in size to preclude said ground ceramic from exiting said storage tank through holes contained therein, and thereafter further adjusted in size to be progressively smaller until said solution is encapsulated within said storage tank.

44. The method of immobilizing radioactive and/or hazardous liquid materials according to claim 42, wherein said ground ceramic is progressively adjusted in size to preclude said ground ceramic from exiting said storage tank through holes which may be later formed therein, and thereafter further adjusted in size to be progressively smaller until said solution is encapsulated within said storage tank.

45. The method of immobilizing radioactive and/or hazardous liquid materials according to claim 41, comprising the further step of pumping microbes into said storage tank by means of said one or more input conduits.

46. The method of immobilizing radioactive and/or hazardous liquid materials according to claim 40, comprising the further step of pumping out solution from said storage tank by means of one or more output conduits.

47. The method of immobilizing radioactive and/or hazardous liquid materials according to claim 46, wherein said one or more output conduits are the same as said one or more input conduits.

48. The method of immobilizing radioactive and/or hazardous liquid materials according to claim 46, wherein said one or more output conduits are different than as said one or more input conduits.

49. The method of immobilizing radioactive and/or hazardous liquid materials according to claim 46, wherein said contact water is removed by said one or more output conduits from said storage tank and recycled to be used again.

50. The method of immobilizing radioactive and/or hazardous liquid materials according to claim 49, wherein said contact water is sufficiently free from said radioactive and/or hazardous liquid materials such that their concentration is below the release limit.

51. The method of immobilizing radioactive and/or hazardous liquid materials according to claim 49, wherein S0₂ and/or S0₃ additional food for microbes; and additional other essential elements for microbes to grow not otherwise present in said storage tank are added to said contact water after it is removed from said storage tank but before it is used again.

52. A method of immobilizing a first set of radioactive and/or hazardous liquid materials contained in soil to be treated to prevent migration of said first set of radioactive and/or hazardous liquid materials from contaminated soil to uncontaminated soil comprising the steps of:
pumping into said soil to be treated one or more solution(s) comprising (i) sulfate and/or sulfite; (ii) food for microbes; (iii) other essential elements for microbes to grow not otherwise present in said soil to be treated; and (iv) a second set of radioactive and/or hazardous liquid materials, wherein said soil to be treated is at least 10 m below ground.

53. The method of immobilizing said first set of radioactive and/or hazardous liquid materials according to claim 52, wherein said soil to be treated comprises an aquifer.

54. The method of immobilizing said first set of radioactive and/or hazardous liquid materials according to claim 52, wherein said soil to be treated comprises a vadoze zone.

55. The method of immobilizing said first set of radioactive and/or hazardous liquid materials according to claim 52, wherein said sulfate and/or sulfite comprises soluble salts of sulfate, sulfite, and/or bisulfite.

56. The method of immobilizing said first set of radioactive and/or hazardous liquid materials according to claim 52, wherein said sulfate and/or sulfite comprises soluble salts of sulfite, and/or bisulfite.

57. The method of immobilizing said first set of radioactive and/or hazardous liquid materials according to claim 52, wherein said food for microbes comprises water soluble organics including vinegar, acetate, lactate, glucose and/or other organics readily digestable by microbes.

58. The method of immobilizing said first set of radioactive and/or hazardous liquid materials according to claim 52, wherein said other essential elements comprise phosphate and/or nitrogen containing compound.

59. The method of immobilizing said first set of radioactive and/or hazardous liquid materials according to claim 52, wherein water is removed by one or more output conduits from said soil to be treated and recycled to be used again.

60. The method of immobilizing said first set of radioactive and/or hazardous liquid materials according to claim 59, wherein S0₂ and/or S0₃; additional food for microbes; and additional other essential elements for microbes to grow not otherwise present in said soil to be treated are added to said water after it is removed from said soil to be treated but before it is used again.
